(19) United States
(12) Patent Application Publication
(10) Pub. No.: US 2005/0083671 A1
(43) Pub. Date: Apr. 21, 2005

(54) Planar-light source device and liquid crystal display apparatus having the same

(76) Inventors: Hae-Il Park, Seoul (KR); Sang-Yu Lee, Yongin-si (KR); Jin-Seob Byun, Seoul (KR); Hyoung-Joo Kim, Uiwang-si (KR)

Correspondence Address: CANTOR COLBURN LLP, 55 Griffin Road South, Bloomfield, CT, 06002, US

(21) Appl. No.: 10/964,747

(22) Filed: Oct. 14, 2004

(30) Foreign Application Priority Data
Oct. 14, 2003 (KR) 2003-71356

(51) Int. Cl. G01D 11/28

(52) U.S. Cl. 362/26

(57) ABSTRACT

A planar-light source device includes a light source body, partition members, a movement restriction member and an electrode. The light source body has a discharge space. The partition members are disposed in the discharge space to divide the discharge space into sub-spaces connected to each other. The movement restriction member is disposed at one of or both the side portions of the respective partition members to restrict plasma movement between the sub-spaces of the discharge space. The electrode surrounds the light source body, and is overlapped with the movement restriction member.

### BACKGROUND OF THE INVENTION

1. Field of the Invention

The present invention relates to a light source device and a liquid crystal display apparatus, and more particularly, to a planar-light source device with partitions that prevent drift current and a liquid crystal display apparatus having the planar-light source device.

2. Description of the Related Art

Generally, liquid crystal has specific electrical and optical characteristics. Arrangement of the liquid crystal is adjusted according to electric fields applied to the liquid crystal, and optical transmittance varies in accordance with the adjustment of the arrangement of the liquid crystal.

A liquid crystal display (LCD) apparatus displays images using the specific electrical and optical characteristic of the liquid crystal. The LCD apparatus has many merits, such as a small volume, a lightweight, etc. Therefore, the LCD apparatus is used in various fields such as a portable computer, a liquid crystal television receiver, etc.

The LCD apparatus generally includes a liquid crystal controlling part and a light providing part. The liquid crystal controlling part includes a first substrate having pixel electrodes, a second substrate having a common electrode, and liquid crystal disposed between the first and second substrates. The number of the pixel electrodes is associated with resolution power of the LCD apparatus. The second substrate generally has a single common electrode. A pixel voltage is applied to corresponding one of the pixel electrodes through a thin film transistor (TFT) that is electrically connected to the pixel electrode. A reference voltage is applied to the common electrode. The pixel electrodes and the common electrode include electrically conductive and optically transparent material.

The light providing part provides the liquid crystal controlling part with light. The light generated from the light providing part passes through the pixel electrodes, the liquid crystal and the common electrode in sequence. Therefore, display quality of the LCD apparatus is influenced by both luminance and uniformity of luminance of the light provided by the light providing part. Generally, when the luminance and the uniformity of luminance are high, display quality of the LCD apparatus is improved.

Generally, the light providing part employs a cold cathode fluorescent lamp (CCFL) having a bar shape or a light emitting diode (LED) having a dot shape. The CCFL has merits, such as high luminance, a long lifespan, and low power consumption in comparison with a glow lamp. The LED has also high luminance, a long lifespan and low power consumption. However, both the CCFL and LED have low uniformity of luminance.

To enhance the uniformity of luminance, the conventional light providing part employs optical members, such as a light guide plate, a diffusion member, a prism sheet, etc. However, employment of these optical members causes an increase in volume and weight.

In order to solve the above-mentioned problems, a planar-light source device for generating planar-light has been developed.

A conventional planar-light source device includes first and second substrates, and partition members interposed between the first and second substrates. The partition members are disposed in parallel such that spaces are created between the partition members that are substantially the same. Therefore, a discharge space is formed between the first and second substrates by the partition members. A sealing member seals the discharge space. A discharge gas is injected into the discharge space.

FIG. 1 is a plan view illustrating a conventional planar-light source device. Referring to FIG. 1, partition members 2 are disposed in an internal space defined by a sealing member 1 to form a discharge space 4. The partition members 2 are disposed in parallel with each other and are equidistant from each other.

First ends of the odd numbered partition members make contact with the sealing member 1, and second ends of the odd numbered partition members are spaced from the sealing member 1. Also, first ends of the even numbered partition members are spaced from the sealing member 1, and second ends of even numbered partition members make contact with the sealing member 1. Therefore, the spaces between adjacent ones of the partition members 2 are connected to each other through a connection passage 5 to form the discharge space 4 having a serpentine shape.

Magnitude of electric fields generated in the discharge space 4 may be different due to non-uniform distribution of the discharge gas. Therefore, a moving path of plasma, represented by the arrow symbol in FIG. 1, becomes short because the spaces between the partition members are directly connected with each other via the connection passage._As a result, drift current is not effectively prevented in the conventional planar-light source device.

Furthermore, since the discharge space 4 has a serpentine shape_of the spaces connected in series, such structure causes an increase in the time for exhausting the discharge gas.

### SUMMARY OF THE INVENTION

The present invention provides a planar-light source device with partitions that prevent drift currents. The present invention also provides a liquid crystal display apparatus having the planar-light source device.

In an exemplary planar-light source device according to the present invention, the planar-light source device includes a light source body, partition members, a movement restriction member and an electrode. The light source body has a discharge space. The partition members are disposed in the discharge space to divide the discharge space into sub-spaces connected to each other. The movement restriction member restricts a movement of plasma between the sub-spaces of the discharge space. The electrode surrounds the light source body, and the electrode is overlapped with the movement restriction member.

In another exemplary planar-light source device according to the present invention, the planar-light source device includes a first substrate, a second substrate, a sealing member, a partition member, a movement restriction member and electrodes. The second substrate faces the first substrate. The sealing member is disposed between the first and second substrates to form a discharge space between the first and second substrates. The partition member is disposed in the discharge space to divide the discharge space into sub-spaces. The partition member has a first end that makes contact with the sealing member and a second end that is spaced apart from the sealing member. The movement restriction member is formed at the second end of the partition member. The movement restriction member restricts a movement of plasma between the sub-spaces of the discharge space. The electrodes surround an outer surface of the first and second substrates, and the electrodes are overlapped with the movement restriction member.

In still another exemplary planar-light source device according to the present invention, the planar-light source device includes a first substrate, a second substrate, a sealing member, a partition member, movement restriction members and electrodes. The second substrate faces the first substrate. The sealing member is disposed between the first and second substrates to form a discharge space between the first and second substrates. The partition member is disposed in the discharge space to divide the discharge space into sub-spaces. The partition member has first and second ends that are spaced apart from the sealing member. The movement restriction members are formed at the first and second ends of the partition member. The movement restriction members restrict a movement of plasma between the sub-spaces of the discharge space. The electrodes surround an outer surface of the first and second substrates, and the electrodes are overlapped with the movement restriction members.

In another embodiment, a liquid crystal display apparatus includes a planar-light source device and a liquid crystal display panel. The planar-light source device includes a light source body, partition members and a movement restriction member. The light source body has a discharge space. The partition members are disposed in the discharge space to divide the discharge space into sub-spaces connected to each other. The movement restriction member restricts a movement of plasma between the sub-spaces of the discharge space. The liquid crystal display panel converts a light generated from the surface light source device into a light containing an image.

According to the present invention, plasma of one sub-space of the discharge space may not easily move to another sub-space of the discharge space. Thus, restricting the movement of plasma effectively prevents or reduces drift current, and connecting the sub-spaces of the discharge space in parallel reduces exhaustion time.

This application relies for priority upon Korean Patent Application No.2003-71356 filed on Oct. 14, 2003, the contents of which are herein incorporated by reference in its entirety.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a plan view illustrating a conventional planar-light source device;

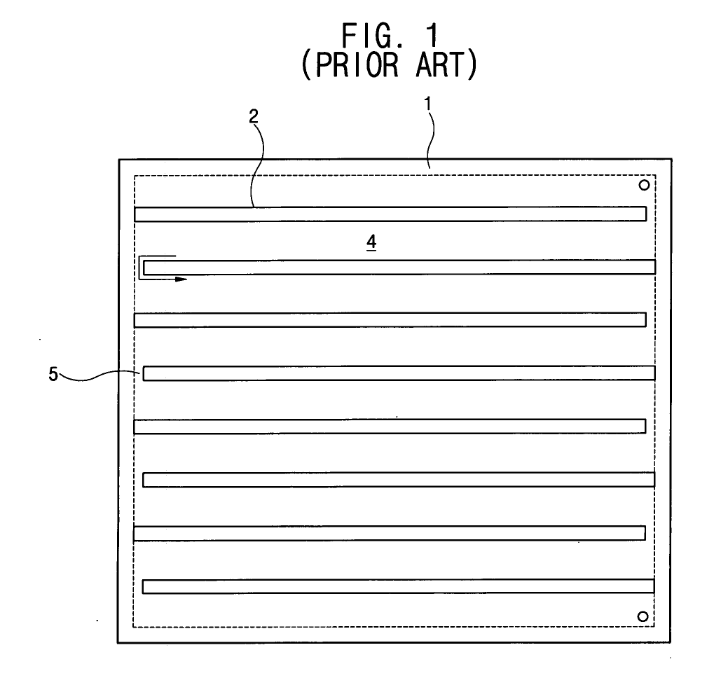

FIG. 2 is a partially cut out perspective view illustrating a planar-light source device according to a first exemplary embodiment of the present invention;

FIG. 3 is a plan view illustrating the planar-light source device in FIG. 2;

FIG. 4 is a cross-sectional view of the planar-light source taken along line IV-IV′ in FIG. 3;

FIG. 5 is a plan view illustrating a planar-light source device according to a second exemplary embodiment of the present invention;

FIG. 6 is a cross-sectional view of the planar-light source taken along line XI-XI′ in FIG. 5;

FIG. 7 is a plan view illustrating a planar-light source device according to a third exemplary embodiment of the present invention;

FIG. 8 is a cross-sectional view of the planar-light source taken along line VIII-VIII′ in FIG. 7;

FIG. 9 is a plan view illustrating a planar-light source device according to a fourth exemplary embodiment of the present invention;

FIG. 10 is a cross-sectional view of the planar-light source taken along line X-X′ in FIG. 9;

FIG. 11 is a plan view illustrating a planar-light source device according to a fifth exemplary embodiment of the present invention;

FIG. 12 is a cross-sectional view of the planar-light source taken along line XII-XII′ in FIG. 11;

FIG. 13 is a plan view illustrating a planar-light source device according to a sixth exemplary embodiment of the present invention;

FIG. 14 is a plan view illustrating a planar-light source device according to a seventh exemplary embodiment of the present invention;

FIG. 15 is a plan view illustrating a planar-light source device according to an eighth exemplary embodiment of the present invention;

FIG. 16 is a plan view illustrating a planar-light source device according to a ninth exemplary embodiment of the present invention;

FIG. 17 is a plan view illustrating a planar-light source device according to a tenth exemplary embodiment of the present invention;

FIG. 18 is a plan view illustrating a planar-light source device according to an eleventh exemplary embodiment of the present invention; and

FIG. 19 is a partially cut out perspective view illustrating a liquid crystal display apparatus according to an embodiment of the present invention.

### DETAILED DESCRIPTION OF THE INVENTION

Hereinafter the exemplary embodiments of the present invention will be described in detail with reference to the accompanied drawings.

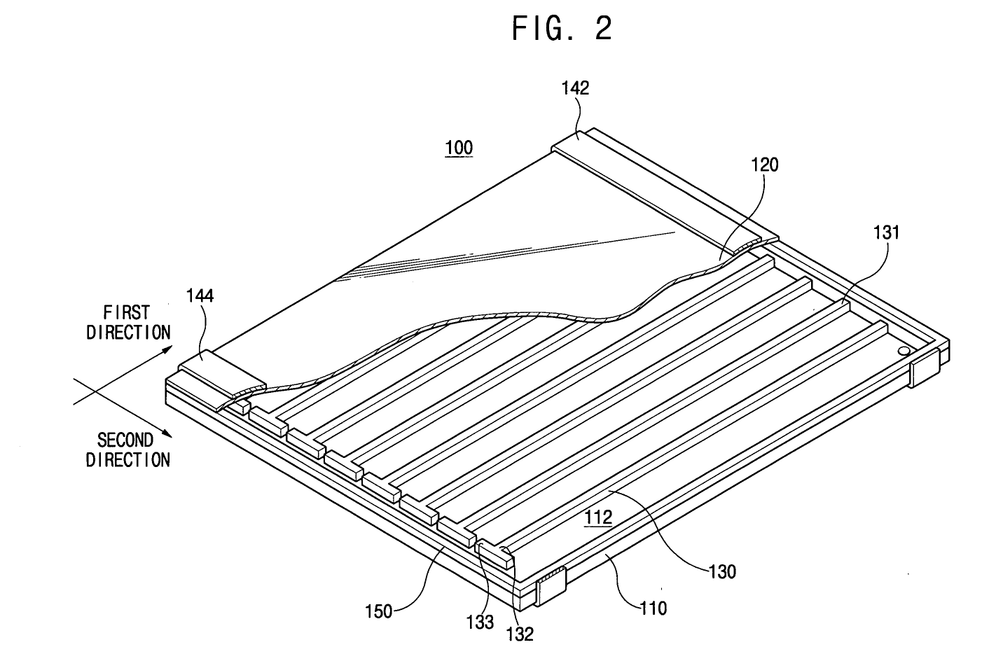

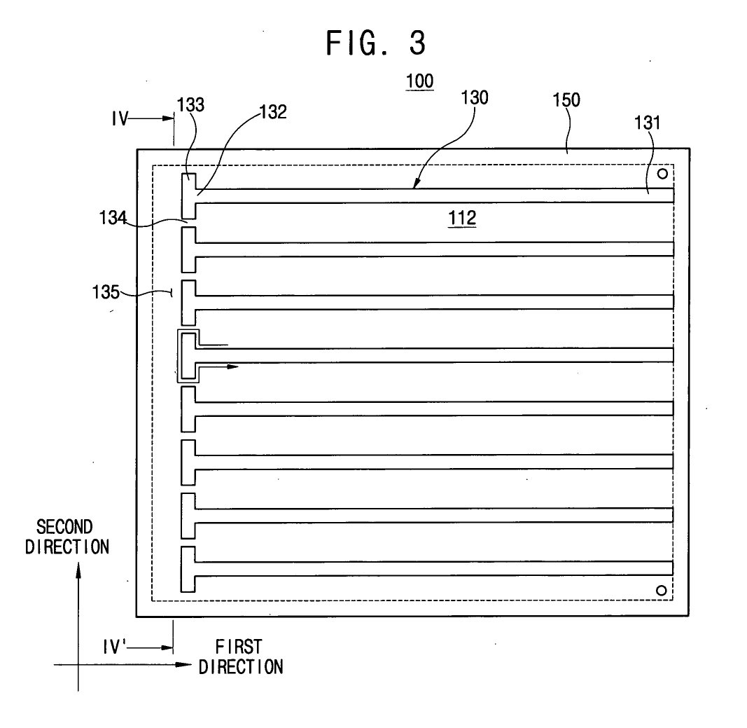

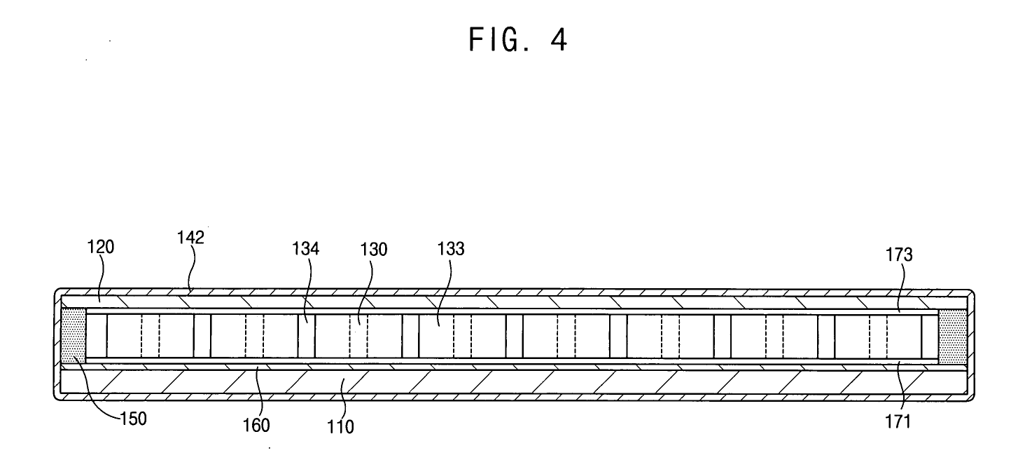

FIG. 2 is a partially cut out perspective view illustrating a planar-light source device according to a first exemplary embodiment of the present invention. FIG. 3 is a plan view of the planar-light source device in FIG. 2. FIG. 4 is a cross-sectional view of the planar-light source device taken along line IV-IV′ in FIG. 3.

Referring to FIGS. 2 to 4, a surface light source device 100 according to a first exemplary embodiment of the present invention includes a light source body, partition members 130, and first and second electrodes 142 and 144. The light source body includes a first substrate 110, a second substrate 120, a lower fluorescent layer 171, an upper fluorescent layer 173 and a sealing member 150.

The first and second substrates 110 and 120 transmit visible light and block ultraviolet light. A glass substrate may be employed as the first and second substrates 110 and 120. The second substrate 120 faces the first substrate 110 such that the second substrate 120 is spaced apart from the first substrate 110. The thickness of the second substrate 120 may be, for example, one third of the thickness of the first substrate 110. The thickness of the second substrate may also be substantially equal to that of the first substrate.

The sealing member 150 has a rectangular frame shape. The sealing member 150 is interposed between the first and second substrates 110 and 120 along edge portion of the first and second substrates 110 and 120. In this embodiment, an upper surface of the sealing member 150 makes contact with a lower surface of the second substrate 120, and a lower surface of the sealing member 150 makes contact with an upper surface of the first substrate 110. Therefore, a discharge space 112 is defined by the first and second substrates 110 and 120 and the sealing member 150. For example, the sealing member 150 has the substantially same thermal expansion coefficient as that of the first and second substrates 110 and 120.

The partition members 130 are disposed between the first and second substrates 110 and 120. In this exemplary embodiment, eight partition members 130 are disposed between the first and second substrates 110 and 120 to form nine sub-spaces of the discharge space 112. The partition members 130 are extended in a first direction and spaced apart from each other by the same distance. The partition members 130 may include an opaque or transparent material.

The partition members 130 each have first and second ends 131 and 132. The first end 131 of each partition member 130 makes contact with the sealing member 150. The second end 132 is spaced apart from the sealing member 150. Therefore, a path 135 through which discharge gas moves is formed between the second end 132 and the sealing member 150. Width of the path is from about 0.5 millimeter (mm) to about 1.0 mm.

The planar-light source device 100 may also have movement restriction members 133 that restrict a movement of plasma. Each movement restriction member 133 is formed at the second end 132 of each partition member 130 such that the second end 132 attaches at a center portion of the movement restriction member 133. In this embodiment, the movement restriction members 133 each have a straight bar shape extended in a second direction that is substantially perpendicular to the first direction. Therefore, a partition member 130 and a corresponding movement restriction member 133 form a T-shape structure. In other words, the longitudinal direction of the movement restriction members 133 is substantially perpendicular to the longitudinal direction of the partition members 130. The movement restriction members 133 are spaced apart from each other forming a plurality of connection passages 134. One connection passage 134 is formed between adjacent ones of the movement restriction members 133. The discharge gas may be injected into the discharge space 112 through the connection passages 134.

A light-reflecting layer 160 is disposed on the upper surface of the first substrate 110. For example, the light-reflecting layer 160 may be a titanium oxide (TiO₃) film or an aluminum oxide (Al₂O₃) film. The light reflecting layer 160 may be formed through a chemical vapor deposition (CVD) method or a sputtering method. The light-reflecting layer 160 reflects light traveling to the first substrate 110 toward the second substrate 120 to enhance luminance.

The upper fluorescent layer 173 is disposed on the lower surface of the second substrate 120. The lower fluorescent layer 171 is disposed on the upper surface of the first substrate 110. In this exemplary embodiment, the lower fluorescent layer 171 is disposed on the light-reflecting layer 160.

First and second electrodes 142 and 144 are disposed on an outer surface of the first and second substrates 110 and 120. In detail, the first electrode 142 surrounds an end portion of the first and second substrates 110 and 120 along the second direction. The first electrode 142 is disposed adjacent to the first ends 131 of the partition members 130. The second electrode 144 surrounds an opposite end portion of the first and second substrates 110 and 120 along the second direction. The second electrode 144 is disposed adjacent to the second ends 132 of the partition members 130. Alternately, one of the first and second electrodes 142 and 144 may be disposed inside the discharge space 112 or both the first and second electrodes 142 and 144 may be disposed inside the discharge space 112. The first and second electrodes 142 and 144 may be spaced apart from sides of the first and second substrates 110 and 120. The first electrode 142 or the second electrode 144 is overlapped with the movement restriction members 133.

The discharge gas is provided to the discharge space 112 partitioned by the partition members 130. In detail, the discharge gas in the path 135 is injected into the respective sub-spaces of the discharge space 112 through the connection passages 134. The sub-spaces of the discharge space 112 are connected to each other, so that the pressure of the discharge space 112 is substantially uniform. The discharge gas includes, for example, mercury (Hg), neon (Ne), etc. The discharge gas may further include, for example, a small amount of argon (Ar), krypton (Kr), xenon (Xe), etc., in order to obtain Penning effect that reduces discharge voltage.

When voltages are applied to the first and second electrodes 142 and 144, molecules of the discharge gas are excited to form plasma in the discharge space 112. When the voltage applied to each of the first and second electrodes 142 and 144 has non-uniform distribution, different electric fields are formed at different sub-spaces of the discharge space 112, so that the plasma moves to a discharge space with the lowest electric fields. In this embodiment, however, the plasma moves along a long path represented by the arrow in FIG. 3 around the respective movement restriction members 133. Therefore, the movement of plasma is restricted and limited so as to effectively prevent drift current.

In addition, the sub-spaces of the discharge space 112 are connected in parallel to one another so that the discharge gas may by injected to the discharge space 112 simultaneously, thereby decreasing manufacturing time.

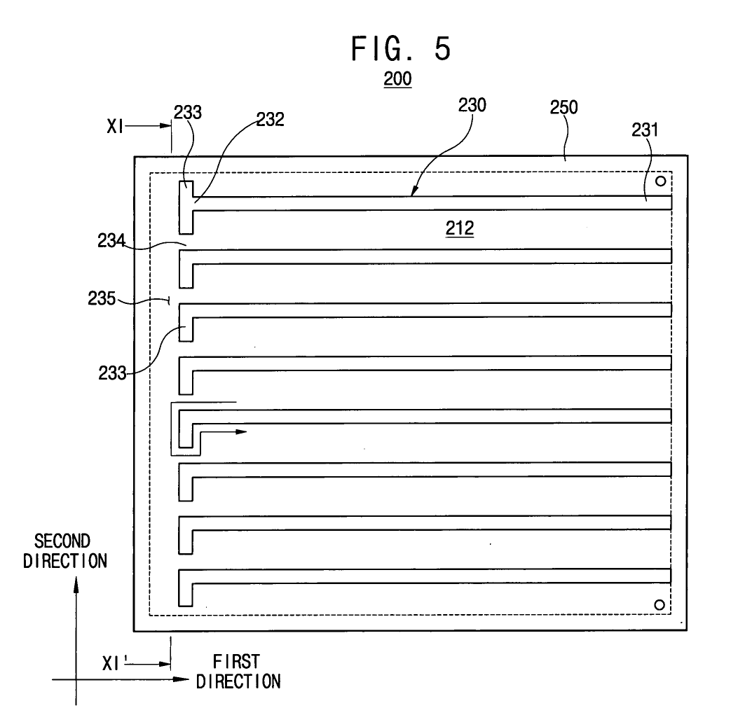

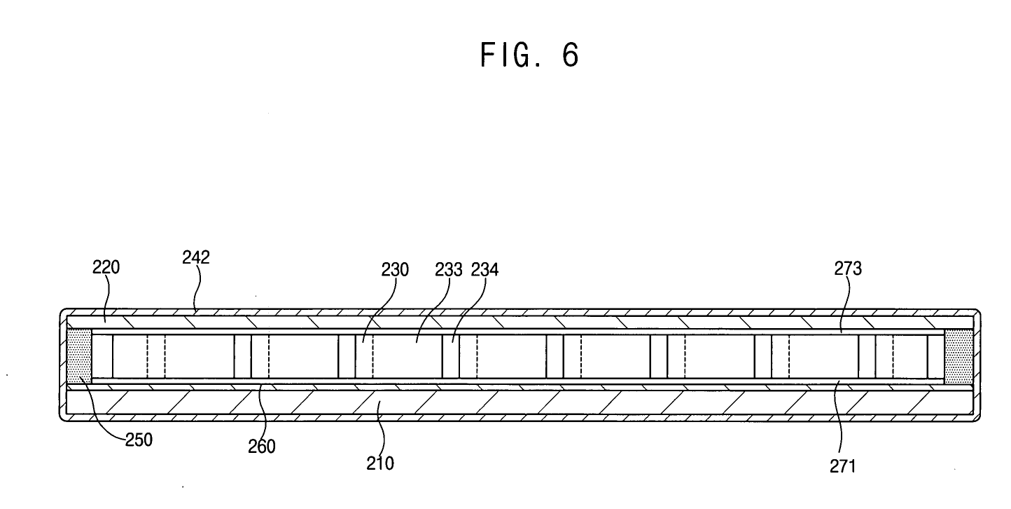

FIG. 5 is a plan view illustrating a planar-light source device according to a second exemplary embodiment of the present invention, and FIG. 6 is a cross-sectional view of the planar-light source device taken along line XI-XI′ in FIG. 5.

Referring to FIGS. 5 and 6, the planar-light source device 200 according to a second exemplary embodiment of the present invention includes a first substrate 210, a second substrate 220, a sealing member 250, partition members 230, movement restriction members 233, first and second electrodes 242, a light reflecting layer 260 that is disposed on an upper surface of the first substrate 210, a lower fluorescent layer 271 disposed on the light reflecting layer 260 and an upper fluorescent layer 273 disposed on a lower surface of the second substrate 220. The sealing member 250 seals a space between the first and second substrates 210 and 220 to form a discharge space 212.

The partition members are disposed between the first and second substrates 210 and 220 to divide the discharge space 212 between the first and second substrates 210 and 220 into a plurality of sub-spaces. In this exemplary embodiment, eight partition members 230 are disposed between the first and second substrates 210 and 220 to divide the discharge space 212 between the first and second substrates 210 and 220 into nine sub-spaces. The partition members 230 are extended in a first direction. Each of the partition members 230 has first and second ends 231 and 232. The first end 231 of the partition member 230 makes contact with the sealing member 250. The second end 232 of the partition member 230 is spaced apart from the sealing member 250. Therefore, a path 235 through which the discharge gas may move is formed between the second end 232 of the partition member 230 and the sealing member 250.

The movement restriction members 233 that restrict a movement of plasma are each formed at the second end 232 of each partition member 230. Each movement restriction member 233 has one end connected with the second end 232 of the corresponding position member 230 and the other end extended in a second direction that is substantially perpendicular to the first direction. Therefore, a partition member 230 and a corresponding movement restriction member 233 form an L-shape structure. In this embodiment, both ends of the first or last movement restriction member 233 are extended in the second direction, so that the first or last movement restriction member 233 and the corresponding partition member 230 form a T-shape structure. The longitudinal direction of the movement restriction member 233 is substantially perpendicular to the longitudinal direction of the partition member 230. The movement restriction members 233 are spaced apart from each other forming a plurality of connection passages 234. One connection passage 234 is formed between adjacent ones of the movement restriction members 233. The discharge gas may be injected into the discharge space 212 through the connection passages 234.

According to the present embodiment, a path of plasma, which is represented by the arrow in FIG. 5, is increased. Therefore, drift current is effectively prevented.

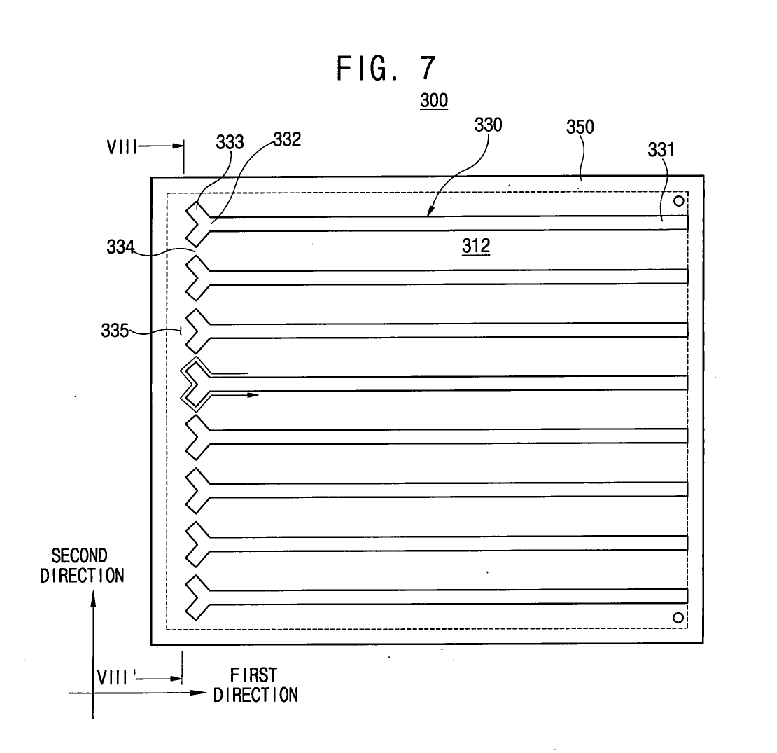

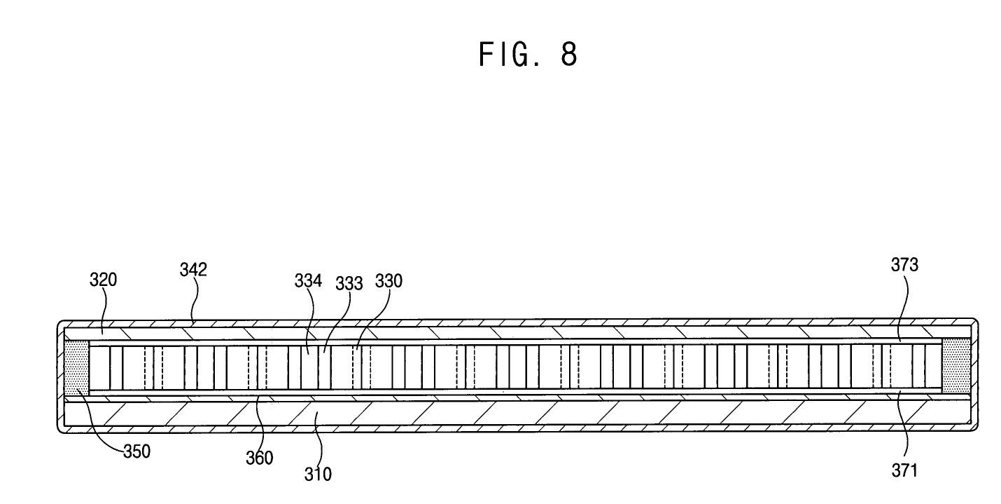

FIG. 7 is a plan view illustrating a planar-light source device according to a third exemplary embodiment of the present invention, and FIG. 8 is a cross-sectional view of the planar-light source device taken along line VIII-VIII′ in FIG. 7.

Referring to FIGS. 7 and 8, the planar-light source device 300 according to a third exemplary embodiment of the present invention includes a first substrate 310, a second substrate 320, a sealing member 350, partition members 330, movement restriction members 333, first and second electrodes 342, a light reflecting layer 360 that is disposed on an upper surface of the first substrate 310, a lower fluorescent layer 371 disposed on the light reflecting layer 360, and an upper fluorescent layer 373 disposed on a lower surface of the second substrate 320. The sealing member 350 seals a space between the first and second substrates 310 and 320 to form a discharge space 312.

In this embodiment, eight partition members 330 are disposed between the first and second substrates 310 and 320 to divide the discharge space 312 between the first and second substrates 310 and 320 into nine sub-spaces. The partition members 330 are each extended in a first direction. Each partition member 330 has first and second ends 331 and 332. The first end 331 of the respective partition members 330 makes contact with the sealing member 350. The second end 332 of the respective partition members 330 is spaced apart from the sealing member 350. Therefore, a path 335 through which the discharge gas may move is formed between the second end 332 of the respective partition members 330 and the sealing member 350.

The movement restriction members 333 are formed at the second end 332 of the respective partition members 330 to restrict the movement of plasma. In this embodiment, the movement restriction members 333 each have a V-shape structure. The second end 332 of the respective partition members 330 makes contact with a center of the V-shaped movement restriction member 333. Therefore, each partition member 330 and a corresponding V-shaped movement restriction member 333 intersect to form a Y-shape. An internal angle between arms of the respective V-shaped movement restriction members 333 is larger than about 0 degrees and smaller than about 180 degrees. The V-shaped movement restriction members 333 are spaced apart from each other forming a plurality of connection passages 334. One connection passage 334 is formed between adjacent ones of the V-shaped movement restriction members 333. The discharge gas may be injected into the discharge space 312 through the connection passages 334.

According to the present embodiment, a path of plasma, which is represented by the arrow in FIG. 7, is increased. Therefore, drift current is effectively prevented.

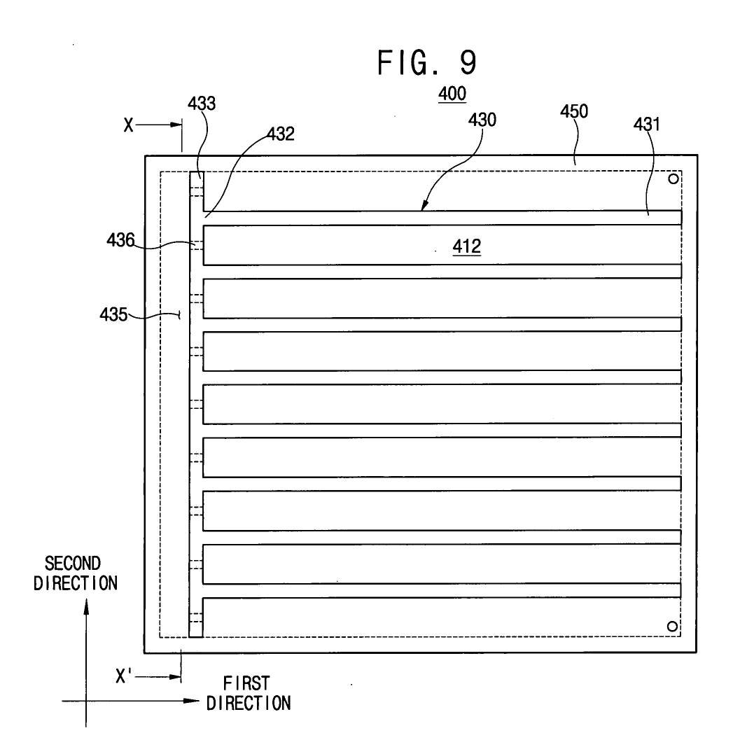

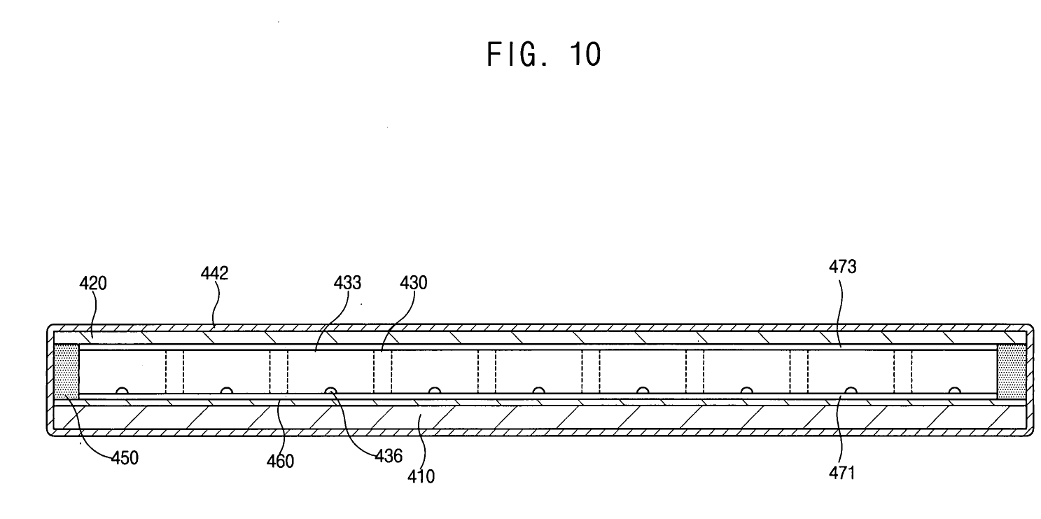

FIG. 9 is a plan view illustrating a planar-light source device according to a fourth exemplary embodiment of the present invention, and FIG. 10 is a cross-sectional view of the planar-light source device taken along line X-X′ in FIG. 9.

Referring to FIGS. 9 and 10, the planar-light source device 400 according to a fourth exemplary embodiment of the present invention includes a first substrate 410, a second substrate 420, a sealing member 450, partition members 430, first and second electrodes 442, a light reflecting layer 460 that is disposed on an upper surface of the first substrate 410, a lower fluorescent layer 471 disposed on the light reflecting layer 460, and an upper fluorescent layer 473 disposed on a lower surface of the second substrate 420. The sealing member 450 seals a space between the first and second substrates 410 and 420 to form a discharge space 412.

In this embodiment, eight partition members 430 are disposed between the first and second substrates 410 and 420 to divide the discharge space between the first and second substrates 410 and 420 into nine sub-spaces. The partition members 430 are extended in a first direction. Each of the partition members 430 has first and second ends 431 and 432. The first end 431 of the respective partition members 430 makes contact with the sealing member 450. The second end 432 of the respective partition members 430 is spaced apart from the sealing member 450. Therefore, a path 435 through which the discharge gas may move is formed between the second end 432 of the respective partition members 430 and the sealing member 450.

A plate-shaped movement restriction member 433 is integrally formed with the partition member 430 to restrict a movement of plasma. The plate-shaped movement restriction member 433 is formed at the second end 432 of the partition member 430. Alternately, the surface light source may include one plate-shaped movement restriction member that is integrally formed with the multiple partition members. The plate-shaped movement restriction member 433 has a long plate shape extended in the second direction. End portions of the plate-shaped movement restriction member 433 make contact with the sealing member 450. Therefore, the discharge space 412 is isolated from the path 435 by the plate-shaped movement restriction member 433.

In order to connect the discharge space 412 to the path 435, the plate-shaped movement restriction member 433 includes a plurality of connection holes 436 with one connection hole 436 corresponding to each subspace of the discharge space 412. Each connection hole 436 connects corresponding subspaces of the discharge space 412 to the path 435. A cross-section of the respective connection holes 436 may have various shapes, such as a circle, a triangle, a rectangle, etc.

For example, the connection holes 436 are each disposed at a lower portion of the plate-shaped movement restriction member 433. Plasma is generally disposed at the upper portion of the discharge space 412. Therefore, when the connection holes 436 are each disposed at the lower portion of the plate-shaped movement restriction member 433, the plasma may not easily flow through the connection holes 436 while the discharge gas may easily flow through the connection holes 436.

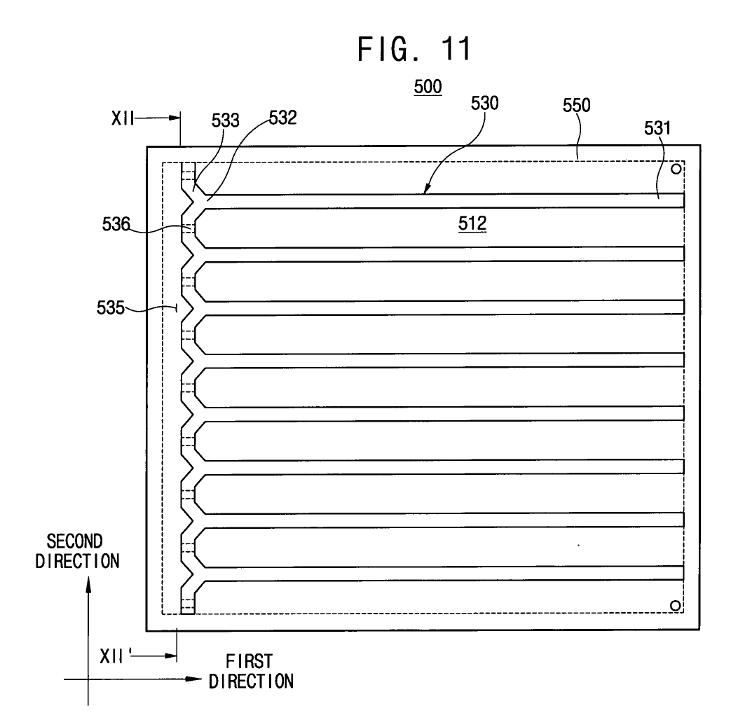

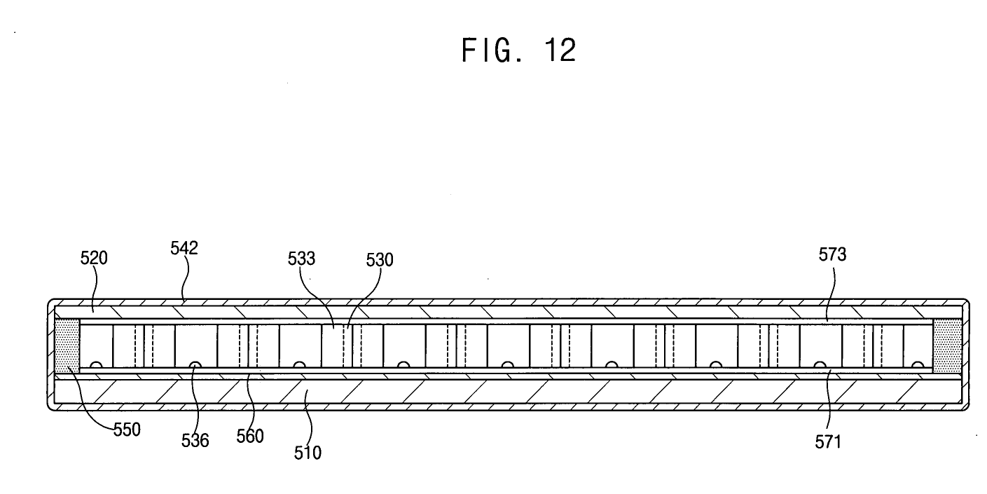

FIG. 11 is a plan view illustrating a planar-light source device according to a fifth exemplary embodiment of the present invention. FIG. 12 is a cross-sectional view of the planar-light source device taken along line XII-XII′ in FIG. 11.

Referring to FIGS. 11 and 12, the planar-light source device 500 according to a fifth exemplary embodiment of the present invention includes a first substrate 510, a second substrate 520, a sealing member 550, partition members 530, first and second electrodes 542, a light reflecting layer 560 that is disposed on an upper surface of the first substrate 510, a lower fluorescent layer 571 disposed on the light reflecting layer 560, and an upper fluorescent layer 573 disposed on a lower surface of the second substrate 520. The sealing member 550 seals a space between the first and second substrates 510 and 520 to form a discharge space 512.

In this embodiment, eight partition members 530 are disposed between the first and second substrates 510 and 520 to divide the discharge space 512 between the first and second substrates 510 and 520 into nine sub-spaces. The partition members 530 are extended in a first direction. Each of the partition members 530 has first and second ends 531 and 532. The first end 531 of the respective partition members 530 makes contact with the sealing member 550. The second end 532 of the respective partition members 530 is spaced apart from the sealing member 550. Therefore, a path 535 through which the discharge gas may move is formed between the second end 532 of the respective partition members 530 and the sealing member 550.

A movement restriction member 533 is integrally formed with corresponding one of the partition members 530 to restrict a movement of plasma. The movement restriction member 533 is formed at the second end 532 of the partition member 530. The movement restriction member 533 has V-shaped arms and each arm is extended in the second direction by a predetermined length. Alternately, the planar-light source may include one movement restriction member that is integrally formed with the multiple partition members 530. In this case, the movement restriction members 533 each have V-shaped arms connected to each other. End portions of the movement restriction member 533 make contact with the sealing member 550. Therefore, the discharge space 512 is isolated from the path 535 by the movement restriction member 533.

In order to connect the discharge space 512 to the path 535, the movement restriction members 533 includes a plurality of connection holes 536 with one connection hole 536 corresponding to each sub-space of the discharge space 512. Each connection hole 536 connects corresponding sub-spaces of the discharge space 512 to the path 535. The connection holes 536 are disposed at lower portion of the V plate-shaped movement restriction member 533 in order to obstruct the plasma in flowing through the connection holes 536. In other words, the connection holes 536 are each disposed at a location where plasma density is relatively lower compared with other locations.

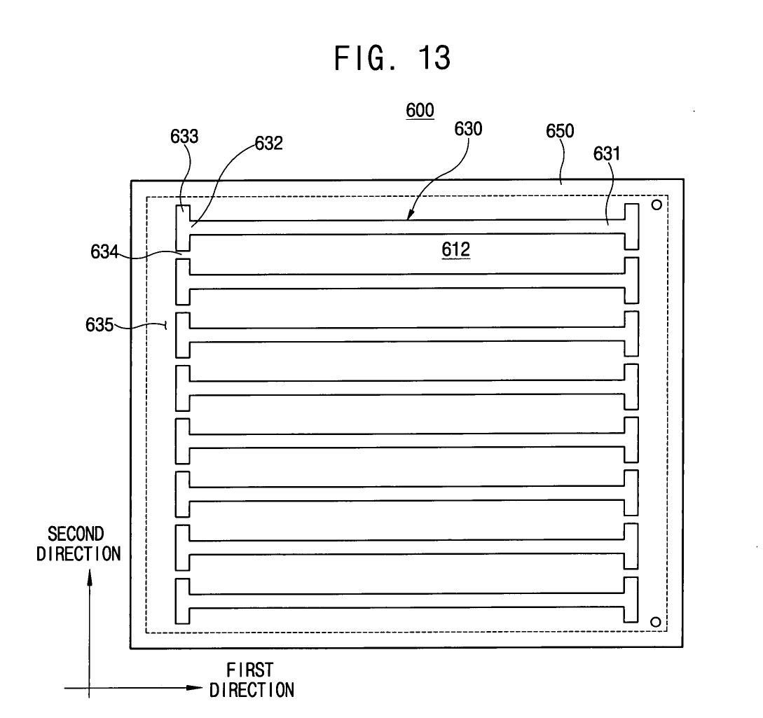

FIG. 13 is a plan view illustrating a planar-light source device according to a sixth exemplary embodiment of the present invention. Referring to FIG. 13, a planar-light source device 600 according to a sixth exemplary embodiment of the present invention includes partition members 630 having first and second ends 631 and 632 that are spaced apart from a sealing member 650. Therefore, a space between the first end 631 and the sealing member 650 and a space between the second end 632 and the sealing member 650 respectively form a path 635 through which discharge gas moves.

In this embodiment, movement restriction members 633 are formed at the first and second ends 631 and 632 of each partition member 630. The movement restriction members 633 each have a bar shape extended in a direction that is substantially perpendicular to a longitudinal direction of the partition members 630, so that a movement restriction member 633 and the corresponding partition member 630 may form a T-shape or L-shape structure. The movement restriction members 633 are spaced apart from each other to form a plurality of connection passages 634. One connection passage 634 is formed for each sub-space of the discharge space 612 through which discharge gas flows.

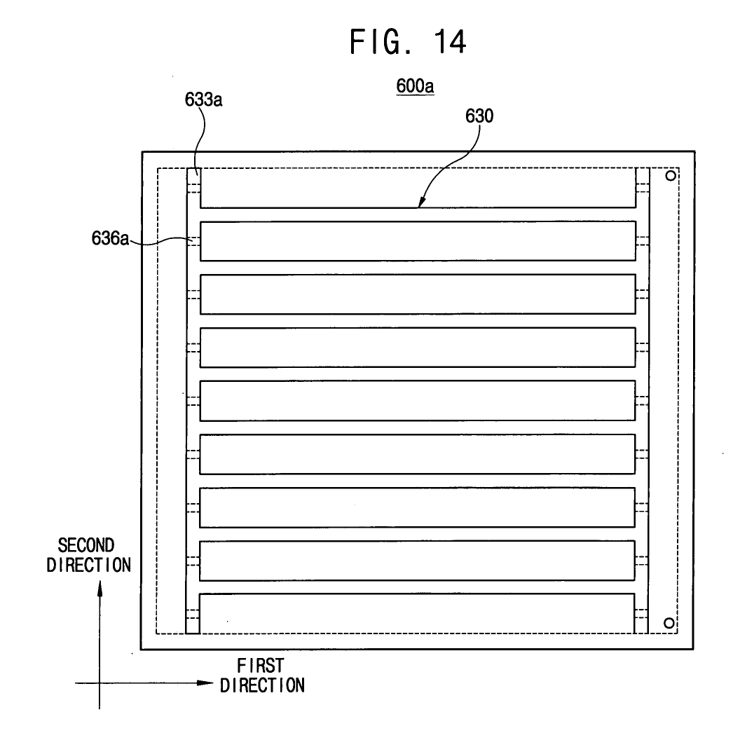

FIG. 14 is a plan view illustrating a planar-light source device according to a seventh exemplary embodiment of the present invention. Referring to FIG. 14, the planar-light source device 600a is a modified embodiment of the sixth embodiment in FIG. 13 and includes a plate-shaped movement restriction member 633a. The plate-shaped movement restriction member 633a includes a plurality of connection holes 636a that connect the discharge space 612 and the path 635. The plate-shaped movement restriction member 633a is integrally formed with the partition members 630 at both the first and second ends thereof.

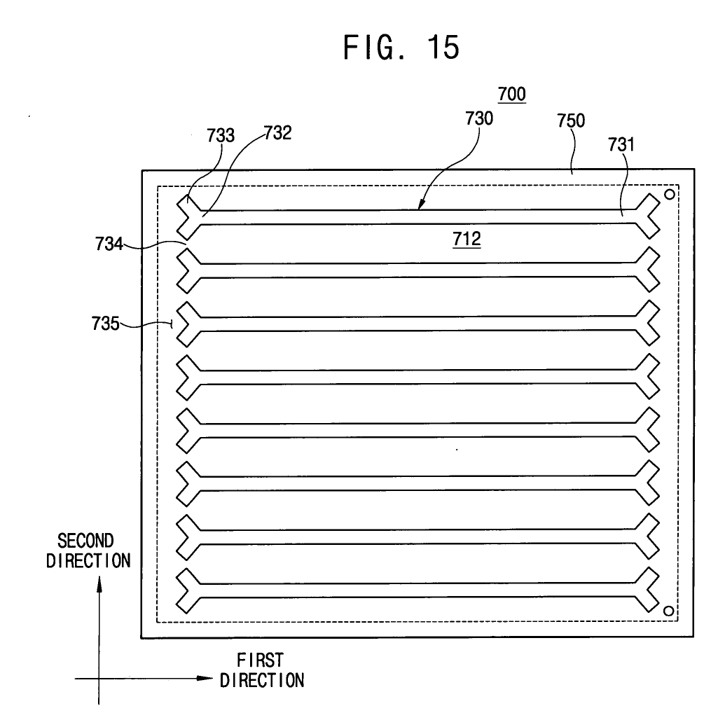

FIG. 15 is a plan view illustrating a planar-light source device according to an eighth exemplary embodiment of the present invention. Referring to FIG. 15, a planar-light source device 700 according to an eighth exemplary embodiment of the present invention includes partition members 730 having first and second ends 731 and 732 that are spaced apart from a sealing member 750. Therefore, a space between the first end 731 and the sealing member 750 and a space between the second end 732 and the sealing member 750 respectively form a path 735 through which discharge gas moves.

In this embodiment, movement restriction members 733 each having V-shaped arms are formed at the first and second ends 731 and 732 of each partition member 730. Each end of the partition members 730 is connected to a center portion of the V-shaped arms of each movement restriction member 733, so that the each partition member 730 intersects the corresponding V-shaped movement restriction member 733 to form a Y-shape structure. The V-shaped movement restriction members 733 are spaced apart from each other to form a plurality of connection passages 734 through which discharge gas flows into the discharge space 712.

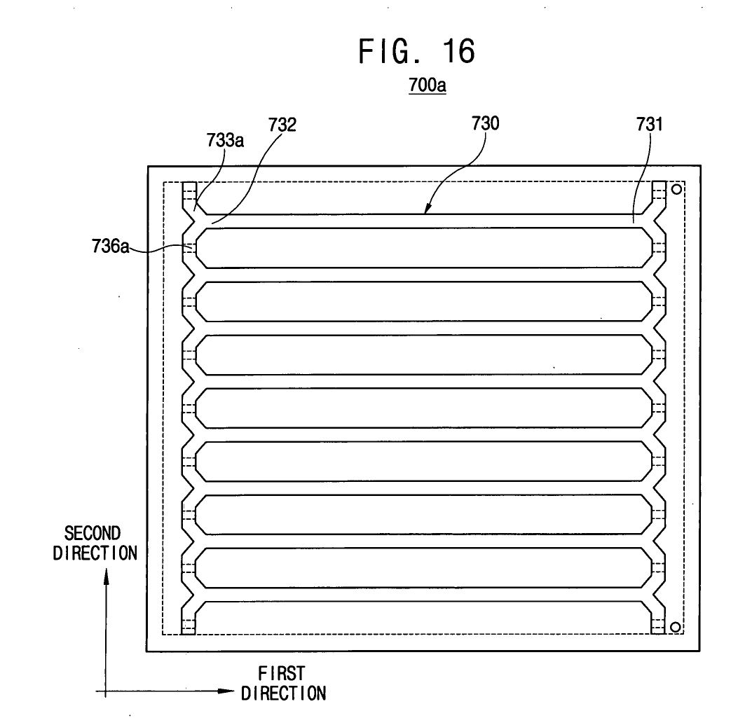

FIG. 16 is a plan view illustrating a planar-light source device according to a ninth exemplary embodiment of the preserit invention. Referring to FIG. 16, the planar-light source device 700a is a modified embodiment of the eighth embodiment in FIG. 15. The planar-light source device 700a includes movement restriction members 733a each having V-shaped arms each of which is extended in the second direction by a predetermined length. A connection passage 736a is formed between adjacent ones of the movement restriction members 733a to connect the discharge space and the path.

Alternately, the planar-light source device 700a may include one movement restriction member 733a disposed at each side of the partition members 730. In this case, two movement restriction members are provided such that one is connected with the first ends of the partition members and the other with the second ends of the partition members. The movement restriction members each have a corresponding connection hole 736a to connect the discharge space and the path.

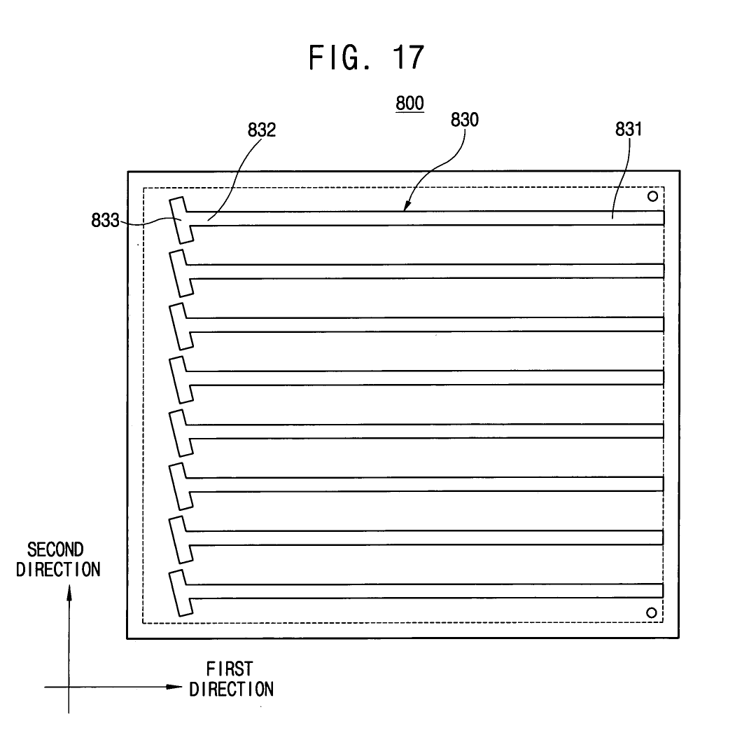

FIG. 17 is a plan view illustrating a planar-light source device according to a tenth exemplary embodiment of the present invention. Referring to FIG. 17, a planar-light source device 800 according to a tenth exemplary embodiment of the present invention includes partition members 830 each having first and second ends 831 and 832. The first end 831 of each partition member 830 makes contact with a sealing member 850. The second end 832 of each partition member 830 is spaced apart from the sealing member 850.

A movement restriction member 833 that hinders the moving of plasma is formed at each of the second ends 832 such that the second ends 832 attach at a center portion of the movement restriction member 833. Each of the movement restriction members 833 forms an acute angle or an obtuse angle with respect to the partition member 830. That is, the movement restriction members 833 are slanted with respect to the partition members 830. In this embodiment, the movement restriction members 833 each have one arm extended from the second end of the partition member 830 at an acute angle with respect to the partition member 830 and the other arm extended from the second end of the partition member 830 at an obtuse angle with respect to the partition member 830.

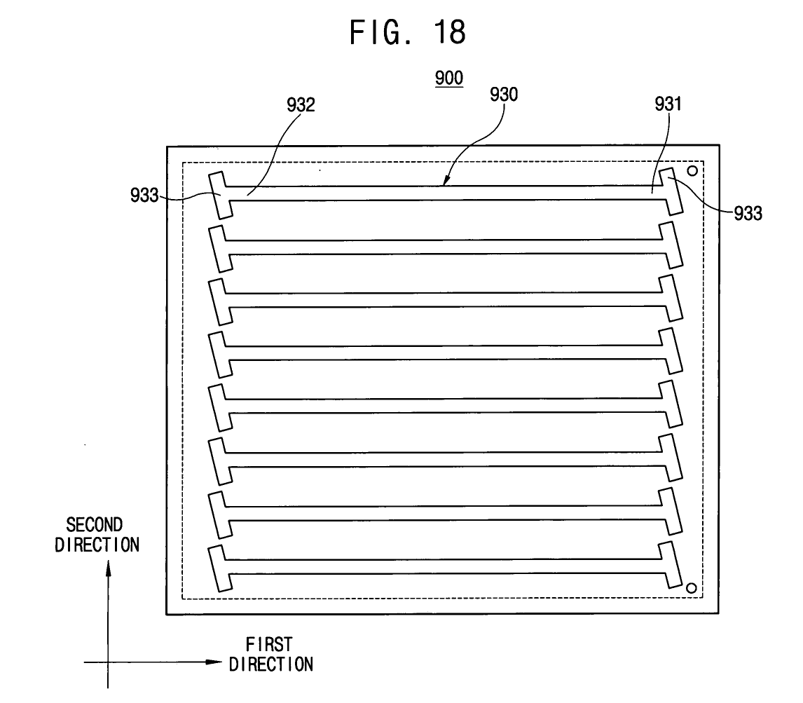

FIG. 18 is a plan view illustrating a planar-light source device according to an eleventh exemplary embodiment of the present invention. Referring to FIG. 18, a planar-light source device 900 according to an eleventh exemplary embodiment of the present invention includes partition members 930 each having first and second ends 931 and 932 that are spaced apart from a sealing member 950.

Movement restriction members 933 that hinder the moving of plasma are formed at the first and second ends 931 and 932 of the respective partition members 930 such that the first and second ends 931 and 932 attach at a center portion of the movement restriction member 933. Each of the movement restriction members 933 forms an acute angle or an obtuse angle with respect to the partition member 930. That is, the movement restriction members 933 are each slanted with respect to the partition member 930 in a similar manner as are the movement restriction members 830 in FIG. 17.

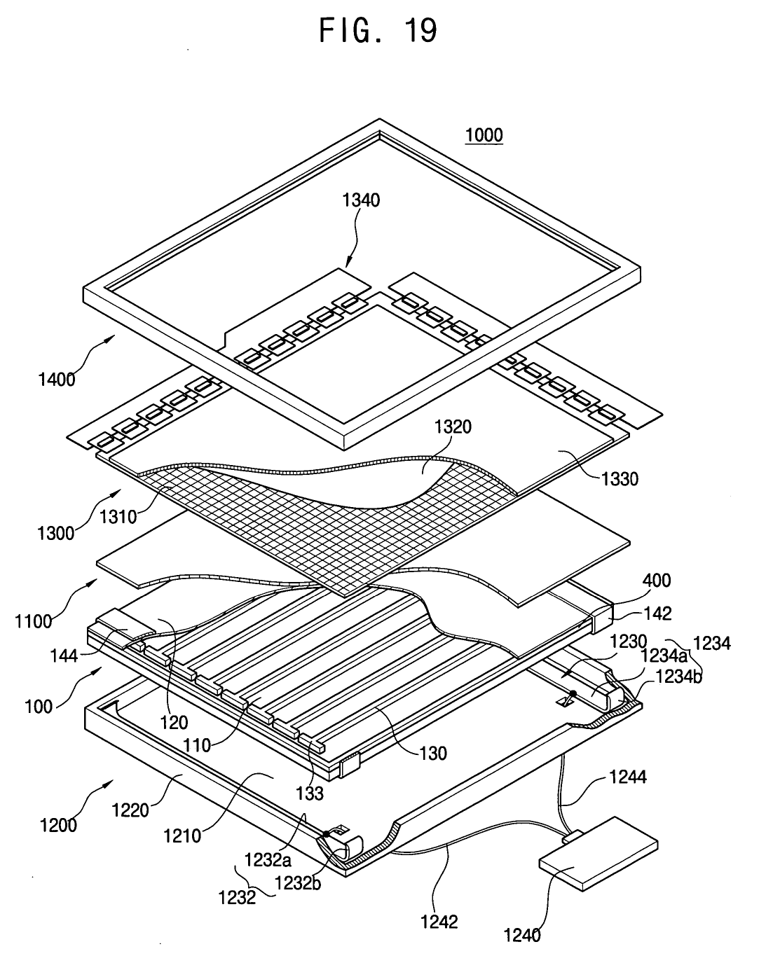

FIG. 19 is a partially cut out perspective view illustrating a liquid crystal display apparatus according to an exemplary embodiment of the present invention. Referring to FIG. 19, a liquid crystal display apparatus according to an exemplary embodiment of the present invention includes a receiving container 1200, a planar-light source device 100, a liquid crystal display panel 1300 and a chassis 1400. The planar-light source device 100 of this embodiment employs the planar-light source device of the first exemplary embodiment in FIG. 2. It should be noted that the liquid crystal display apparatus 1000 may employ one of the planar-light source devices described above.

The receiving container 1200 includes a bottom plate 1210, sidewalls 1220 formed at edge portion of the bottom plate 1210 to form a receiving space, a discharge voltage applying module 1230 and an inverter 1240. The receiving container 1200 fixes the planar-light source device 100 and the liquid crystal display panel 1300. The bottom plate 1210 has sufficient area for supporting the planar-light source device 100 and substantially the same shape as the planar-light source device 100. The bottom plate 1210 and the planar-light source device 100 have, for example, a rectangular shape. The sidewalls 1220 fix the planar-light source device 100 to prevent the separation or movement of the planar-light source device 100.

The discharge voltage applying module 1230 applies a discharge voltage to a discharge voltage applying part 1230 of the planar-light source device 100. The discharge voltage applying part 1230 includes first and second discharge voltage applying modules 1232 and 1234. An insulating unit (not shown) is disposed between the bottom plate 1210 and the first and second discharge voltage applying modules 1232 and 1234 so that the receiving container 1200 is electrically insulated from the discharge voltage applying part 1230. The insulating unit (not shown) may include an insulating layer, an insulating plate, an insulating piece, etc.

The first discharge voltage applying module 1232 includes a first conducting body 1232a and a first conducting clip 1232b formed at the first conducting body 1232a. The second discharge voltage applying module 1234 includes a second conducting body 1234a and a second conducting clip 1234b formed at the second conducting body 1234a. The first and second electrodes 142 and 144 of the planar-light source device 100 are connected to the first and second conducting clips 1232b and 1234b, respectively, so that the planar-light source device 100 is combined with the receiving container 1200.

The inverter 1240 applies discharge voltages to the first and second discharge voltage applying modules 1232 and 1234. The inverter 1240 is electrically connected to the first discharge voltage applying module 1232 through a first wire 1242, and the inverter 1240 is electrically connected to the second discharge voltage applying module 1234 through a second wire 1244.

The liquid crystal display panel 1300 displays images using light generated from the planar-light source device 100. The liquid crystal display panel includes a thin film transistor (TFT) substrate 1310, a liquid crystal layer 1320, a color filter substrate 1330 and a driver module 1340. The TFT substrate 1310 includes pixel electrodes that are arranged in a matrix shape, TFTs applying pixel voltages to the pixel electrodes, gate lines and data lines.

The color filter substrate 1330 includes color filters facing the pixel electrodes and a common electrode formed on the color filters. The liquid crystal layer 1320 is interposed between the TFT substrate 1310 and the color filter substrate 1330.

The chassis 1400 enwraps edge portions of the liquid crystal display panel 1300, and the chassis 1400 is combined with the receiving container 1200 by a hook connection. The chassis 1400 protects the liquid crystal display panel 1300 and prevents the liquid crystal display panel 1300 from being separated from the receiving container 1200. The liquid crystal display apparatus 1000 may further include an optical property-enhancing member 1100. A mold frame (not shown) may be disposed between the planar-light source device 100 and the optical property-enhancing member 1100 to support the optical property-enhancing member 1100 so that the planar-light source device 100 is spaced apart from the optical property-enhancing member 1100.

According to the present invention, plasma of a sub-space of the discharge space may not easily move to another sub-space of the discharge space. That is, moving of plasma is restricted so as to reduce or effectively prevent drift current. Furthermore, the subspaces of the discharge space are connected in parallel through the path. Therefore, exhaustion time is reduced.

Having described the exemplary embodiments of the present invention and its advantages, it is noted that various changes, substitutions and alterations can be made herein without departing from the spirit and scope of the invention as defined by appended claims.

1. A planar-light source device comprising:
a light source body having a discharge space;
partition members disposed in the discharge space to divide the discharge space into sub-spaces connected to each other;
a movement restriction member that restricts a movement of plasma between the sub-spaces of the discharge space, the movement restriction member being disposed in connection with the partition members; and
an electrode surrounding the light source body, the electrode being overlapped with the movement restriction member.

2. The planar-light source device of claim 1, wherein the light source body comprises:
a first substrate;
a second substrate facing the first substrate; and
a sealing member interposed between the first and second substrates to form the discharge space between the first and second substrates.

3. The planar-light source device of claim 1, wherein each of the partition members has a first end that makes contact with the light source body and a second end that is spaced apart from the light source body.

4. The planar-light source device of claim 3, wherein the movement restriction member has a plurality of sections each of which is extended along a direction substantially perpendicular to a longitudinal direction of the partition members and attached to the second end of each partition member.

5. The planar-light source device of claim 4, wherein the sections of the movement restriction member are spaced apart from the light source body and adjacent ones of the sections of the movement restriction member are spaced apart from each other, so that the plasma moves from one sub-space to another sub-space via a passage formed between the adjacent sections of the movement restriction member.

6. The planar-light source device of claim 3, wherein the movement restriction member is connected with the second end of the respective partition members and is extended in a direction substantially perpendicular to a longitudinal direction of the partition members.

7. The planar-light source device of claim 6, wherein the movement restriction member connected with the partition members is spaced apart from the light source body.

8. The planar-light source device of claim 7, wherein the movement restriction member has first and second ends in contact with opposite sides, respectively, of the light source body, and the movement restriction member has connection holes that connect the sub-spaces of the discharge space to each other.

9. The planar-light source device of claim 8, wherein the connection holes are each disposed at a location where plasma density is relatively lower compared with other locations of the movement restriction member.

10. The planar-light source device of claim 3, wherein the movement restriction member has a plurality of sections each having V-shaped arms, the sections of the movement restriction member being spaced apart from each other and each attached to the second end of each partition member.

11. The planar-light source device of claim 10, wherein a passage is formed between adjacent ones of the sections of the movement restriction member, so that the plasma moves from one sub-space to another sub-space via the passage.

12. The planar-light source device of claim 3, wherein the movement restriction member is connected to the second end of the respective partition members and has a plurality of V-shaped arms connected to each other.

13. The planar-light source device of claim 12, wherein the movement restriction member has first and second ends in contact with opposite sides, respectively, of the light source body, and the movement restriction member has connection holes that connect the sub-spaces of the discharge space to each other.

14. The planar-light source device of claim 13, wherein the connection holes are each disposed at a location where plasma density is relatively lower compared with other locations of the movement restriction member.

15. The planar-light source device of claim 3, wherein the movement restriction member has a plurality of sections each of which is connected to the second end of each partition member, the sections of the movement restriction member being each slanted with respect to corresponding one of the partition members.

16. The planar-light source device of claim 1, wherein each of the partition members has first and second ends at each of which the movement restriction member is formed.

17. The planar-light source device of claim 16, wherein the movement restriction member has a plurality of sections each of which is extended along a direction substantially perpendicular to a longitudinal direction of the partition members and attached to corresponding one of the partition members.

18. The planar-light source device of claim 17, wherein the sections of the movement restriction member are spaced apart from each other, so that the plasma moves from one sub-space to another sub-space via a passage formed between adjacent ones of the sections.

19. The planar-light source device of claim 16, wherein the movement restriction member is connected with the first or second ends of all the partition members and is extended in a direction substantially perpendicular to a longitudinal direction of the partition members.

20. The planar-light source device of claim 19, wherein the movement restriction member has first and second ends in contact with opposite sides, respectively, of the light source body, and the movement restriction member has connection holes that connect the sub-spaces of the discharge space to each other.

21. The planar-light source device of claim 20, wherein the connection holes are each disposed at a location where plasma density is relatively lower compared with other locations of the movement restriction member.

22. The planar-light source device of claim 16, wherein the movement restriction member has a plurality of sections having V-shaped arms, the sections of the movement restriction member being spaced apart from each other and each attached corresponding one of the partition members.

23. The planar-light source device of claim 22, wherein a passage is formed between adjacent ones of the sections of the movement restriction member, so that the plasma moves from one sub-space to another sub-space via the passage.

24. The planar-light source device of claim 16, wherein the movement restriction member is connected with all the partition members and has a plurality of V-shaped arms connected to each other.

25. The planar-light source device of claim 24, wherein the movement restriction member has first and second ends in contact with opposite sides, respectively, of the light source body, and the movement restriction member has connection holes that connect the sub-spaces of the discharge space to each other.

26. The planar-light source device of claim 25, wherein the connection holes are each disposed at a location where plasma density is relatively lower compared with other locations of the movement restriction member.

27. The planar-light source device of claim 16, wherein the movement restriction member has a plurality of sections each of which is connected corresponding one of the partition members, the sections of the movement restriction member being each slanted with respect to corresponding one of the partition members.

28. The planar-light source device of claim 1, wherein the electrode surrounds an end portion of the light source body such that a longitudinal direction of the electrode is substantially perpendicular to a longitudinal direction of the partition members.

29. A planar-light source device comprising:
a first substrate;
a second substrate facing the first substrate;
a sealing member disposed between the first and second substrates to form a discharge space between the first and second substrates;
a partition member disposed in the discharge space to divide the discharge space into sub-spaces, the partition member having a first end that makes contact with the sealing member and a second end that is spaced apart from the sealing member;
a movement restriction member formed at the second end of the partition member, the movement restriction member restricting a movement of plasma between the sub-spaces of the discharge space; and
an electrode surrounding outer surface of the first and second substrates, the electrode being overlapped with the movement restriction member.

30. The planar-light source device of claim 29, wherein the movement restriction member is a plate-shaped member disposed such that a longitudinal direction of the movement restriction member is substantially perpendicular to a longitudinal direction of the partition member, and the movement restriction member has first and second ends that make contact with opposite sides, respectively, of the sealing member and connection holes connecting the sub-spaces of the discharge space with each other.

31. The planar-light source device of claim 30, wherein the connection holes are each disposed at a location where plasma density is relatively lower compared with other locations of the movement restriction member.

32. A planar-light source device comprising:
a first substrate;
a second substrate facing the first substrate;
a sealing member disposed between the first and second substrates to form a discharge space between the first and second substrates;
a partition member disposed in the space to divide the discharge space into sub-spaces, the partition member having first and second ends that are spaced apart from the sealing member;
movement restriction members formed at the first and second ends, respectively, of the partition member, the movement restriction members restricting a movement of plasma between the sub-spaces of the discharge space; and
an electrode surrounding outer surface of the first and second substrates, the electrode being overlapped with the movement restriction members.

33. The planar-light source device of claim 32, wherein the movement restriction members are each a plate-shaped member disposed such that a longitudinal direction of the movement restriction members is substantially perpendicular to a longitudinal direction of the partition member, and the movement restriction members each have first and second ends that make contact with opposite sides, respectively, of the sealing member and connection holes connecting the sub-spaces of the discharge space with each other.

34. The planar-light source device of claim 33, wherein the connection holes are each disposed at a location where plasma density is relatively lower compared with other locations of the movement restriction member.

35. A liquid crystal display apparatus comprising:
a planar-light source device including a light source body having a discharge space, partition members disposed in the discharge space to divide the discharge space into sub-spaces connected to each other, a movement restriction member that is disposed in connection with the partition members to restrict a movement of plasma between the sub-spaces of the discharge space, and an electrode that surrounds the light source body, the electrode being overlapped with the movement restriction member; and
a liquid crystal display panel that displays images using light generated from the planar-light source device.

36. The liquid crystal display apparatus of claim 35, wherein the movement restriction member has a plurality of sections each attached to an end of corresponding one of the partition members, the plasma moving from one sub-space to another sub-space via a passage formed between adjacent ones of the sections of the movement restriction member.

37. The liquid crystal display apparatus of claim 35, wherein the movement restriction member is attached to an end of the respective partition members and has longitudinal ends in contact with opposite sides, respectively, of the light source body, the movement restriction member having connection holes that connect the sub-spaces of the discharge space to each other.

38. The liquid crystal display apparatus of claim 35, wherein the movement restriction member has a plurality of sections each having V-shaped arms, the sections of the movement restriction members being spaced apart from each other, attached to an end of corresponding one of the partition members, the plasma moving from one sub-space to another sub-space via a passage formed between adjacent ones of the sections of the movement restriction member.

39. The liquid crystal display apparatus of claim 35, wherein the movement restriction member has a plurality of sections each having V-shaped arms, the sections of the movement restriction members being connected to each other and each attached to an end of corresponding one of the partition members, the movement restriction member having connection holes that connect the sub-spaces of the discharge space to each other.

40. The liquid crystal display apparatus of claim 35, wherein the movement restriction member has a plurality of sections each attached to an end of corresponding one of the partition members, and the sections of the movement restriction members are each slanted with respect to corresponding one of the partition members, the plasma moving from one sub-space to another sub-space via a passage formed between adjacent ones of the sections of the movement restriction member.
